(19) United States
(12) Patent Application Publication
(10) Pub. No.: US 2003/0184516 A1
(43) Pub. Date: Oct. 2, 2003

(54) Information processing unit and method of controlling orientation

(75) Inventor: Takashi Sakurai, Ome-shi (JP)

Correspondence Address: Finnegan, Henderson, Farabow,, Garrett & Dunner, L.L.P., 1300 I Street,N.W., Washington, DC, 20005-3315, US

(73) Assignee: KABUSHIKI KAISHA TOSHIBA

(21) Appl. No.: 10/352,922

(22) Filed: Jan. 29, 2003

(30) Foreign Application Priority Data
Mar. 29, 2002 (JP) 2002-097998

(51) Int. Cl. G09G 5/00

(52) U.S. Cl. 345/156

(57) ABSTRACT

A rotation management utility program stores, in a setting table, whether a pointing direction of each pointing device or the like is to be rotated in response to rotation of a displayed picture. Then, when the program has been instructed to rotate the displayed picture, the rotation management utility program notifies it to a device driver which controls display of an LCD through a display controller. Thereafter, the program refers to the setting table to find whether there are any devices whose pointing directions should be rotated in response to the rotation of the displayed picture. If there are, the rotation management utility program notifies thereof to a device driver associated with the device.

### CROSS-REFERENCE TO RELATED APPLICATIONS

This application is based upon and claims the benefit of priority from the prior Japanese Patent Application No. 2002-097998, filed Mar. 29, 2002, the entire contents of which are incorporated herein by reference.

### BACKGROUND OF THE INVENTION

1. Field of the Invention

The present invention relates to an information processing unit, such as a notebook computer, and a method of controlling the orientation of the information processing. In particular, it relates to an information processing unit and a method of controlling the orientation of the information processing, which enables improvement in the operability thereof in the case a displayed picture is rotated.

2. Description of the Related Art

In recent years, personal computers of various types, such as notebook and desk-top types, have come into wide use. Further, the display picture of modern personal computers can be rotated by 90 degrees, for example, on a display device having a rectangular display area, such that the display device can be used even in which direction, vertically or horizontally, the longitudinal direction of the display device is located.

When the display screen is rotated by using this function, the direction of operation of a pointing device, such as a mouse, in some cases, is different from the direction of movement of the cursor on the display. More specifically, it is caused that, when a mouse is moved rightward, the cursor on the picture moves upward. In such a case, without any measures, the operability of the computer is greatly reduced.

In consideration of the above, an electronic apparatus with tablet in Jpn. Pat. Appln. KOKAI Pub. No. 6-324805 performs counterchange of functions of push-buttons, change of indicating directions of a cross-shaped button, and coordinate transformation of the tablet, in response to rotation of the display direction of a display.

In the meantime, the housings of notebook personal computers are being increasingly thinned, and in some computers a lid can be opened to 180 degrees such that the display provided on its inner wall surface is directed straight up. Therefore, let's consider the situation in which two facing people view the display directed straight up, such as when one of them makes a presentation to the other by using the display device.

In such a case, the user (presenter) rotates the picture by 180 degrees to set the keyboard in a direction in which the user can easily operate it, and sets the display such that it can be easily viewed by the other person. Further, in the above electronic apparatus with tablet of Jpn. Pat. Appln. KOKAI Pub. No. 6-324805, functions of push-buttons are counterchanged, indicating directions of a cross-shaped switch are changed, and the coordinate of the tablet is transformed, in response to rotation of the display direction of a display. Therefore, even when the picture is viewed upside down, the user can operate the pointing device easily by simply moving it in the same direction as that on the display.

In the meantime, for example, if the user uses a touch pad set on the keyboard and the other person uses a mouse connected externally, although the indicating direction of the touch pad is rotated in accordance with the rotation of the picture, it is preferred that the pointing direction of the mouse is maintained in the usual direction. However, it is presently impossible to control the pointing direction of individual pointing devices.

### BRIEF SUMMARY OF THE INVENTION

Embodiments of the invention may provide an information processing unit comprising: a display unit; an operating unit configured to perform various operations on the basis of a picture displayed on the display; a picture rotating unit configured to rotate the picture; a setting unit configured to perform setting whether the pointing direction of the operating unit is rotated or not, when the picture is rotated by the picture rotating unit, in response to the rotation; and a direction controlling unit configured to rotate, when the picture is rotated, the pointing direction of the operating unit in response to the rotation, if the pointing direction of the operating unit has been set by the setting unit to be rotated in response to the rotation.

Further, the embodiments of the invention may provide a method of controlling an operating direction of an information processing unit, the information processing unit comprising: a display unit; an operating unit configured to perform various operations based on a picture displayed on the display unit; and a picture rotating unit configured to rotate the picture, the method comprising: setting whether a pointing direction of the operating unit is rotated or not, when the picture is rotated by the picture rotating unit, in response to the rotation; and rotating, when the picture is rotated, the pointing direction of the operating unit in response to the rotation, if the pointing direction of the operating unit has been set to be rotated in response to the rotation.

According to the embodiments of the invention, in the case where a picture on a display directed straight up is viewed by two users and the picture is rotated by 180 degrees, it is possible to maintain the pointing direction of one of pointing devices used by the two users and rotate only the pointing direction of the other pointing device in response to rotation of the picture. Specifically, the embodiments of the invention improves the operability of the information processing unit whose display picture has been rotated.

Additional embodiments and advantages of the invention will be set forth in the description which follows, and in part will be obvious from the description, or may be learned by practice of the invention. The embodiments and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an appearance of an information processing unit concerning an embodiment of the invention.

FIG. 2 is a diagram showing a hardware structure of the information processing unit of the embodiment.

FIG. 3 is a diagram showing a software structure of the information processing unit of the embodiment.

FIG. 4 is a diagram for explaining the situation of use of the information processing unit supposed in the embodiment.

FIG. 5 is a diagram for explaining a user interface provided by a rotation management utility program operating in the information processing unit of the embodiment.

FIG. 6 is a flow chart showing an operation process for control of the operating direction performed in the information processing unit of the embodiment.

FIG. 7 is a diagram for explaining an example of an application of the information processing unit of the embodiment.

### DETAILED DESCRIPTION OF THE INVENTION

An embodiment of the invention will now be described with reference to the drawings.

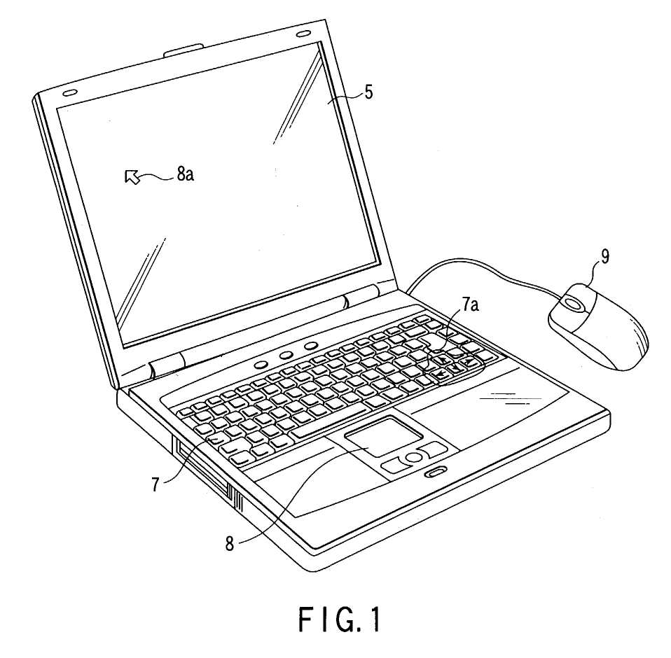

FIG. 1 is a diagram showing an appearance of an information processing unit concerning an embodiment of the present invention. As shown in FIG. 1, the information processing unit is a notebook personal computer, in which a LCD 5 is provided on an inside surface of a lid portion. Further, a keyboard 7 including scroll keys 7a and a touch pad 8 are provided on a main body portion opposed to the lid portion. The scroll keys 7a are keys for scrolling an image on the picture displayed on the LCD 5 up and down and right and left. The touch pad 8 is a pointing device for moving a mouse cursor 8a, which is displayed on the picture in a superposed manner, in a desired direction.

Further, a mouse 9, which is a pointing device for moving the mouse cursor 8a in a desired direction like the touch pad 8, can be connected to the main body portion of the information processing unit, according to necessity.

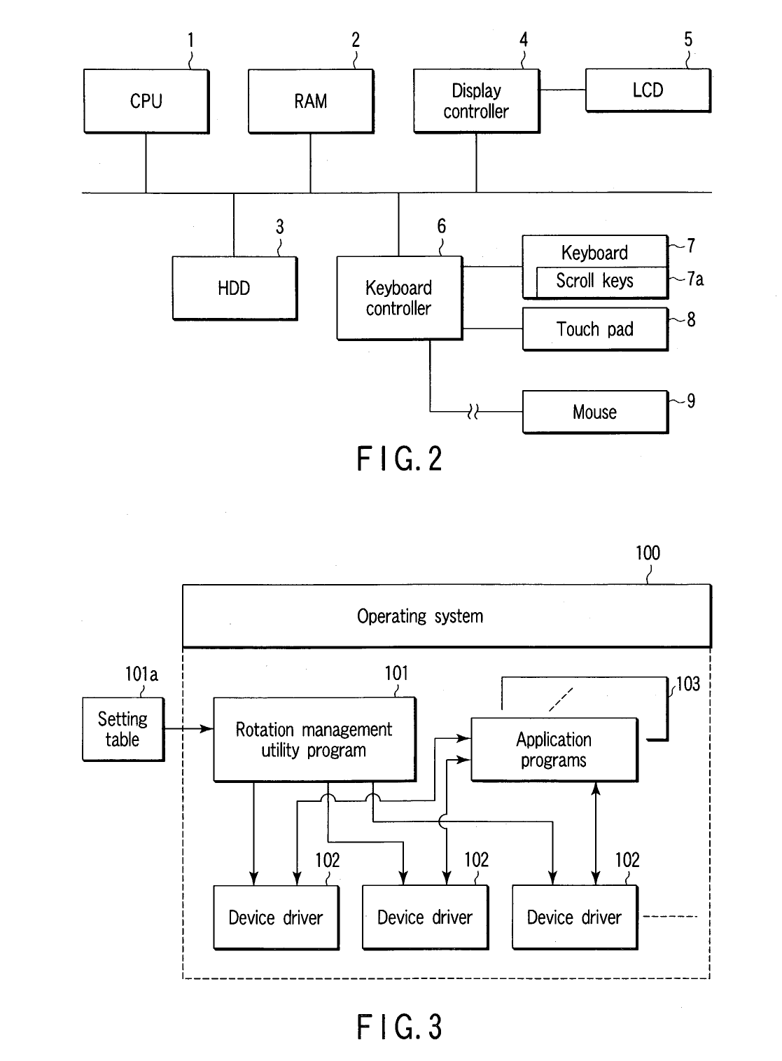

FIG. 2 is a diagram showing a hardware structure of the information processing unit.

As shown in FIG. 2, the information processing unit has a CPU 1, RAM 2, magnetic disk unit 3, display controller 4 and keyboard controller 6, in addition to the LCD 5, keyboard 7, touch pad 8 and mouse 9 shown in FIG. 1.

The CPU 1 drives and controls the whole information processing unit. The CPU 1 executes an operating system, and various programs such as utility programs and application programs, stored in the RAM 2. Further, the RAM 2 is a memory device serving as a main storage of the information processing unit. The RAM 2 stores the various programs to be executed by the CPU 1, and various data to be inputted in and outputted from the programs. In the meantime, the magnetic disk unit 3 is a memory device serving as an external storage of the information processing unit. The magnetic disk unit 3 stores various programs and data in large quantities, as an auxiliary device of the RAM 2.

The display controller 4 manages outputs of user interfaces in the information processing unit, and controls display of image data prepared by the CPU 1 on the LCD 5. In the meantime, the keyboard controller 6 manages inputs of the user interfaces in the information processing unit, and transmits operations of the keyboard 7, touch pad 8, and mouse 9 to the CPU 1.

Further, FIG. 3 is a diagram showing a software structure of the information processing unit.

As shown in FIG. 3, in the information processing unit, a rotation management utility program 101, various device drivers 102, and various application programs 103 operate under control of an operating system 100.

The rotation management utility program 101 is a program for realizing a direction control which is an advantageous feature of the information processing unit. The program 101 provides a user interface for performing various settings concerning rotation of the display picture and, based on the settings, notifies the device driver 102 associated with a device whose pointing direction should be rotated to do so. Further, the rotation management utility program 101 has a setting table 101a for holding the contents of settings by the user.

The device drivers 102 intervene between the application programs 103 and respective various devices, such that the application programs 103 being software can use the devices being hardware. For example, rotation of the picture to be displayed on the LCD 5, and rotation of pointing directions of the scroll keys 7a of the keyboard 7, touch pad 8 and mouse 9 are controlled by the respective device drivers 102 associated with them. Further, the application programs 103 are a group of “work programs”, such as word processing software and spreadsheet software, which the user uses according to necessity.

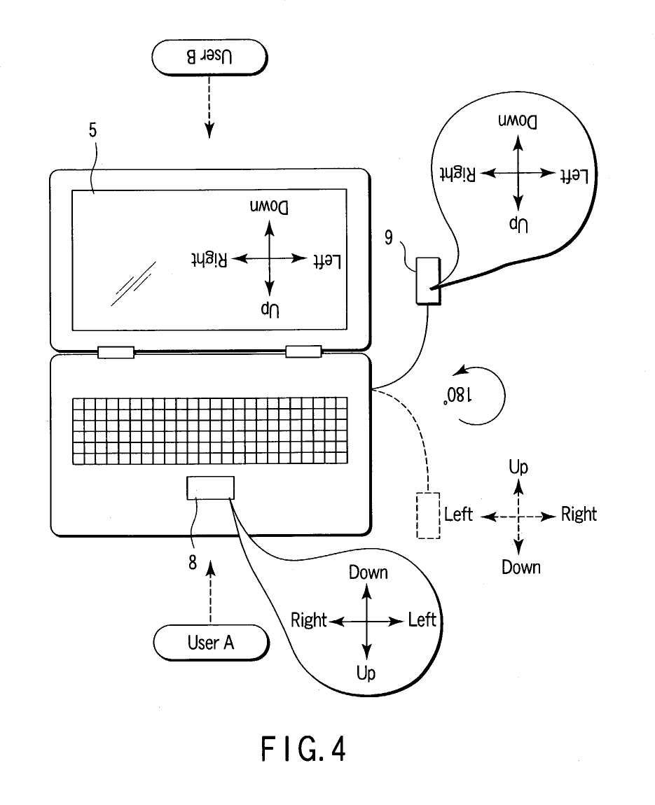

Suppose that the information processing unit is used under the situation shown in FIG. 4. Specifically, the LCD 5 is directed to face straight up, and two users of A and B view the LCD 5, facing each other, and the user A uses the touch pad 8 and the user B uses the mouse 9. Further, in the situation, the picture on the LCD 5 is rotated by 180 degrees such that the user B can easily view it.

In such a situation, first, in the user A's place, it is desirable to also rotate the pointing direction of the touch pad 8 by 180 degrees, to agree it with the moving direction of the mouse cursor 8a when the mouse cursor 8a is moved by using the touch pad 8. In the meantime, in the user B's place, it is desirable that the pointing direction of the mouse 9 is maintained, because the pointing direction has already been agreed with the moving direction of the mouse cursor 8a by rotating the mouse 9 by 180 degrees. Therefore, the information processing unit provides a mechanism in which the rotation management utility program 101 individually performs setting for each device whether the pointing direction of the device is rotated in response to the rotation of the picture.

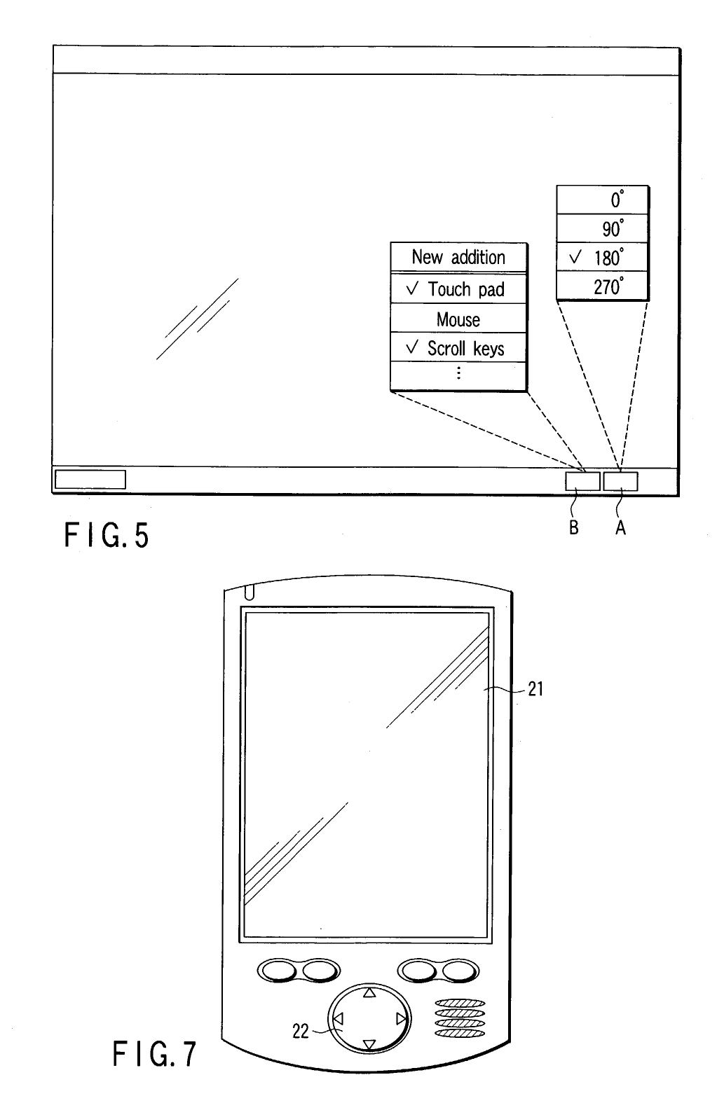

FIG. 5 is a diagram for explaining a user interface provided by the rotation management utility program 101.

As shown in FIG. 5, the rotation management utility program 101 displays, in a lower edge portion of the picture, for example, a task bar A for indicating rotation of the picture, and a task bar B for individually setting whether the pointing direction of the touch pad 8 and mouse 9 and the like is to be rotated or not in response to the rotation of the picture.

If the task bar A is clicked, the rotation management utility program 101 displays choices of rotation angles, such as “0 degree”, “90 degrees”, “180 degrees” and “270 degrees”. Then, when any of the angles has been selected, the rotation management utility program 101 notifies the device driver 102, which controls the display of the LCD 5 through the display controller 4, of the selected angle. Then, the device driver 102 which has been notified thereof rotates the picture to be displayed on the LCD 5 by the notified angle. When the use of the unit under the situation shown in FIG. 4 is to be started, the user clicks the task bar A, and selects the angle “180 degrees”. Further, also when the use under the situation shown in FIG. 4 is terminated, the task bar A is clicked again and the angle “0 degree” is selected.

In the meantime, when the task bar B is clicked, the rotation management utility program 101 displays a setting picture for setting for individual devices whether the pointing direction of the device is rotated or not. In the example shown in FIG. 5, it is set that the pointing directions of the “touch pad” and “scroll keys” are rotated in response to the rotation of the picture, while the pointing direction of the “mouse” does not rotate in response to the rotation of the picture. Further, the rotation management utility program 101 stores the setting contents in the setting table 101a.

For example, when the picture is rotated by 180 degrees by using the task bar A, the rotation management utility program 101 refers to the setting table 101a, and recognizes that it is necessary to rotate the pointing directions of the “touch pad” and “scroll keys” in response to the rotation of the picture. Further, the rotation management utility program 101 notifies thereof to the device driver 102 which controls operation of the touch pad 8 through the keyboard controller 6, and to the device driver 102 which controls operation of the keyboard 7 including the scroll keys 7a through the keyboard controller 6. Then, the device drivers 102 which have been notified thereof rotate the respective pointing directions of the touch pad 8 and the scroll keys 7a by 180 degrees.

Further, The item “New Addition” in the task bar B is an item for adding a newly added pointing device other than the “touch pad”, “mouse” and “scroll keys” to the choices in the task bar B. When the item “New Addition” is selected, the rotation management utility program 101 refers to the operating system 100 for a list of the devices, and shows the list of the devices obtained thereby to the user. Then, the rotation management utility program 101 adds the device selected from the shown list to the choices in the task bar B.

Specifically, owing to the rotation management utility program 101, each of the device drivers 102 can be dedicated to management of rotation of the pointing direction of the device whose operation the device driver controls. In other words, owing to the rotation management utility program 101, the unit can incorporate a plurality of devices which are driven and controlled by the device drivers 102 having no connection with each other, and achieve a total management as to whether the pointing directions of the devices should be rotated in response to rotation of the picture.

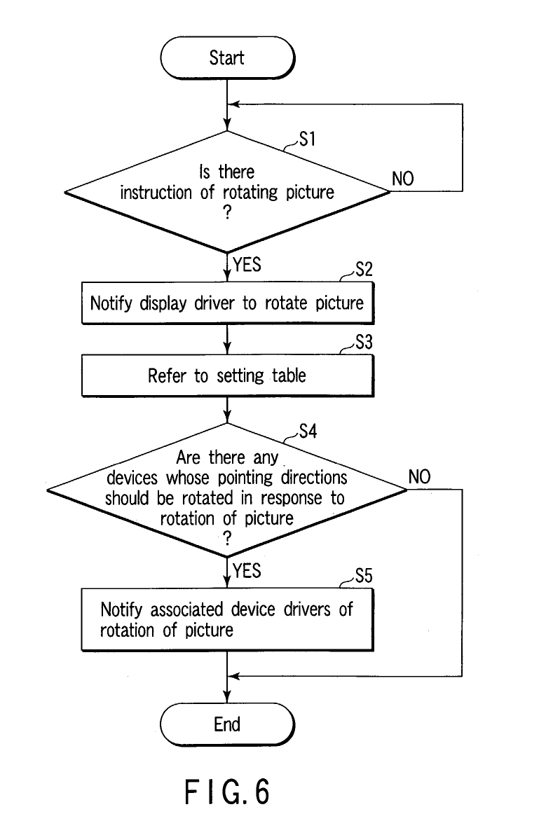

Next, the operation process of direction control performed in the information processing unit will be explained with reference to FIG. 6.

When an instruction of rotating the picture is issued (YES of Step S1), the rotation management utility program 101 first notifies the device driver 102, which controls display of the LCD 5 through the display controller 4, of the instruction (Step S2).

Subsequently, the rotation management utility program 101 refers to the setting table 101a (Step S3), to find whether there are any devices whose pointing directions should be rotated in response to the rotation of the picture (Step S4). Then, if there are (YES of Step S4), the rotation management utility program 101 notifies thereof to the device drivers 102 associated with the devices (Step S5).

As described above, in the information processing unit, the rotation management utility program 101 provides a mechanism of setting for individual devices whether the pointing direction of the device should be rotated or not in response to rotation of the picture. Therefore, it is possible to improve operability of both of the user A and the user B, in the situation in which the LCD 5 is directed straight up to be viewed by two users of the user A and user B facing each other and the user A uses the touch pad 8 and the user B uses the mouse 9, as shown in FIG. 4.

Further, although the example of controlling the pointing directions of the scroll keys, touch pad and mouse of in a notebook personal computer was explained above, the present invention is not limited to it, but can be applied to various devices of various equipments. For example, the present invention can also be applied to a personal digital assistance called PDA and the like, as shown in FIG. 7, comprising a tablet-integral-type display 21, and cross-shaped switch 22 for selecting items shown on the picture displayed on the display. In such a case, first, even if a device driver which controls rotation of the picture and a device driver which controls transformation of coordinates on the tablet are separate products having no connection with each other, it is possible to easily perform transformation of coordinates on the tablet in response to rotation of the picture. Secondly, the cross-shaped switch 22 can be flexibly used, for example, the pointing direction of the cross-shaped switch 22 is rotated in response to rotation of the picture in some cases and maintained as it is, not in response to the rotation of the picture in other cases.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing unit comprising:
a display unit;
an operating unit configured to perform various operations on the basis of a picture displayed on the display;
a picture rotating unit configured to rotate the picture;
a setting unit configured to perform setting whether the pointing direction of the operating unit is rotated or not; and
a direction controlling unit configured to rotate, when the picture is rotated, the pointing direction of the operating unit, if the pointing direction of the operating unit has been set by the setting unit to be rotated.

2. The information processing unit according to claim 1, wherein the operating unit is a pointing device for pointing any position on the picture.

3. The information processing unit according to claim 1, wherein the operating unit is scroll keys for scrolling the picture up and down and right and left.

4. The information processing unit according to claim 1, wherein the operating unit is a cross-shaped key for selecting any item shown on the picture.

5. The information processing unit according to claim 1, wherein the display unit forms a unitary one-piece structure together with a tablet, and the direction controlling unit having a transforming unit configured to transform coordinates on the tablet.

6. The information processing unit according to claim 1, wherein the setting unit performs the setting individually for a plurality of the operating unit.

7. The information processing unit according to claim 6, wherein the setting unit having a user interface unit configured to show a picture for performing the setting.

8. The information processing unit according to claim 6, further comprising adding unit configured to add the operating unit to be processed by the setting unit.

9. The information processing unit according to claim 1, wherein the picture rotating unit configured to rotate the picture by any angle of 90 degrees, 180 degrees and 270 degrees.

10. The information processing unit according to claim 9, wherein the picture rotating unit having a user interface unit configured to show a picture for setting a rotation angle of the picture.

11. A method of controlling an operating direction of an information processing unit, the information processing unit comprising: a display unit; an operating unit configured to perform various operations based on a picture displayed on the display unit; and a picture rotating unit configured to rotate the picture, the method comprising:
setting whether a pointing direction of the operating unit is rotated or not; and
rotating, when the picture is rotated, the pointing direction of the operating unit in response to the rotation, if the pointing direction of the operating unit has been set to be rotated.

12. The method according to claim 11, wherein the operating unit is a pointing device for pointing any position on the picture.

13. The method according to claim 11, wherein the operating unit is scroll keys for scrolling the picture up and down and right and left.

14. The method according to claim 11, wherein the operating unit is a cross-shaped key for selecting any item shown on the picture.

15. The method according to claim 11, wherein the display unit forms a unitary one-piece structure together with a tablet, and the rotating including transforming coordinates on the tablet.

16. The method according to claim 11, wherein the setting performing the setting individually for a plurality of the operating unit.

17. The method according to claim 11, the setting including showing a picture for performing the setting.

18. The method according to claim 16, further comprising adding the operating unit to be processed by the setting.

19. The method according to claim 11, wherein the picture rotating unit configured to rotate the picture by any angle of 90 degrees, 180 degrees and 270 degrees.

20. The method according to claim 19, wherein the picture rotating unit having a user interface unit configured to show a picture for setting a rotation angle of the picture.
